(19) United States
(12) Patent Application Publication
(10) Pub. No.: US 2017/0355635 A1
(43) Pub. Date: Dec. 14, 2017

(54) FEEDBACK-CONTROLLED LASER CUTTING OF FLEXIBLE GLASS SUBSTRATES

(71) Applicant: Corning Incorporated, Corning, NY (US)

(72) Inventor: Xinghua Li, Horseheads, NY (US)

(21) Appl. No.: 15/527,556

(22) PCT Filed: Nov. 18, 2015
(86) PCT No.: PCT/US15/61251

§ 371 Date: May 17, 2017

Related U.S. Application Data
(60) Provisional application No. 62/082,383, filed on Nov. 20, 2014.

(51) Int. Cl. C03B 33/09; B23K 26/03; B23K 26/354; B23K 26/146; B23K 26/356; B23K 103/00

(52) U.S. Cl. CPC C03B 33/091; B23K 26/146; B23K 26/356; B23K 26/03; B23K 26/354; B23K 2203/54

(57) ABSTRACT

A method of cutting thin flexible glass substrates utilizing a feedback loop configured to monitor a position of a crack tip relative to an irradiated zone on the glass substrate. A process controller including the feedback loop controls at least one of a laser beam power, a laser speed or a cooling fluid speed based on the distance between the crack tip and the irradiated zone.

This application claims the benefit of priority under 35 U.S.C. §119 of U.S. Provisional Application Ser. No. 62/082383 filed on Nov. 20, 2014 the content of which is relied upon and incorporated herein by reference in its entirety.

### BACKGROUND

### Field

The present invention relates generally to cutting brittle materials, and more particularly to the separation of thin glass substrates utilizing a feedback loop to monitor and/or control crack tip position.

### Technical Background

While laser cutting of relatively thick glass sheets is well known and studied, the processing of very thin glass sheets raises new challenges primarily as a result of the rapid thermal equalization that occurs through the thickness of the glass sheet when heated, for example with a laser. In typical laser cutting operations applied against glass sheets having a thickness equal to or greater than, for example, 0.7 mm, a laser beam is used to heat the glass along a predetermined path. A cooling fluid is applied against the heated path and the resulting stress field can cause a pre-existing flaw, such as a small crack, to extend and propagate across the glass. Generally, such processes are used to produce a crack that extends only partially through the glass substrate owing to the inability of the heat produced by the incident laser beam, and subsequent cooling, to extend sufficiently below the incident surface to set up the necessary tensile stress field at a speed of interest to industrial applications. The result is a score line that is a crack extending across at least a major portion of the surface, but not through the thickness of the glass. Final separation is performed by applying a tensile stress perpendicular to the score line, such as by bending. The resultant tensile stress drives the partial crack through the remainder of the glass thickness, thereby completely separating the glass.

Thin glass sheets, for example substrates having a thickness equal to or less than about 0.3 millimeters (mm), behave differently during cutting operations because the heating, and subsequent cooling, extend rapidly through the thickness of the glass substrate, requiring different techniques to produce mirror-like finishes to the newly-formed edge surfaces produced by the crack propagation. Importantly, at crack propagation speeds of 0.1 meters/second and above, the relationship between speed and stress intensity has a slope of approximately 40, so that a 1× change in stress intensity is equivalent to a 40× change in crack speed.

As a result, it is important for edge quality and separation to ensure that crack tip speed is controlled.

### SUMMARY

The present disclosure describes a laser cutting apparatus for cutting thin flexible glass substrates (e.g. glass substrates with a thickness equal to or less than about 0.3 millimeter) and a method of using the apparatus. The apparatus employs a feedback loop based on crack tip position relative to an irradiation zone produced by a laser beam incident on a major surface of the glass substrate. A fast image acquisition apparatus images the position of the crack tip relative to the irradiation zone produced by the incident laser beam in real time and feeds that information to a process controller. The digital image is processed in a process controller, for example a computer or other suitable data processing device. Alternatively, the image can be processed at the location where the image is taken using reconfigurable field-programmable gate array technology, for example. Depending on the crack tip position relative to the irradiation zone, the process controller may send a control signal to the laser and a position signal to a laser beam steering device. The control signal may modulate the laser power, for example by varying a control voltage to the laser, thereby enabling the crack tip to propagate at a generally constant distance from the irradiation zone as the irradiation zone traverses a pre-determined cut path on the glass substrate. Such a technique can produce a laser-cut edge that exhibits minimal-to-no strength limiting crack irregularities.

In one embodiment, a method of cutting a brittle material, such as a glass, a glass ceramic or a ceramic material, is disclosed comprising heating the brittle material along a predetermined cut path with a laser beam, the laser beam forming an irradiation zone on a surface of the brittle material where the brittle material is heated at the irradiation zone, cooling the brittle material along the predetermined cut path with a cooling fluid after the heating, thereby causing a crack to propagate along the cut path, detecting a position of a leading tip of the crack relative to a reference location of the irradiation zone and calculating a distance between the crack tip position and the reference location, comparing the calculated distance to a predetermined set distance, and modifying at least one of a power of the laser beam, a traverse speed of the irradiation zone or a traverse speed of the cooling fluid in response to a difference between the calculated distance and the predetermined set distance. A thickness of the brittle material may be equal to or less than about 0.3 millimeters. For example, the thickness t of the brittle material may be in a range from about 0.3 millimeters to about 0.05 millimeters, in a range from about 0.25 millimeters to about 0.05 millimeters, in a range from about 0.2 millimeters to about 0.05 millimeters, in a range from about 0.15 millimeters to about 0.05 millimeters, or in a range from about 0.05 millimeters, including all ranges and subranges therebetween. In one example, the reference location is a mid-point of the irradiation zone. However, in other examples the reference location can be the leading tip of the irradiation zone, the trailing tip of the irradiation zone, or any point therebetween. The predetermined set distance can be in a range from about 0 millimeters to about 50 millimeters, for example in a range from about 0 millimeters to about 45 millimeters, from about 0.05 millimeters to about 40 millimeters, from about 0.05 millimeters to about 30 millimeters, from about 0.05 millimeters to about 25 millimeters, including all ranges and subranges therebetween.

The step of detecting the crack tip can comprise illuminating the crack with an illumination source. In certain examples, the illumination source illuminates the crack with dark field illumination. The illumination source may illuminate the crack with line illumination.

The step of detecting the crack tip may comprise imaging the crack with an imaging apparatus.

In another embodiment, a method of cutting a brittle material is described comprising heating a brittle material along a predetermined cut path on a surface of the brittle material with a laser beam incident on the surface of the brittle material. The brittle material may be a glass substrate, a glass ceramic substrate or a ceramic substrate. A thickness of the brittle material equal to or less than about 0.3 millimeters. For example, the thickness of the brittle material may be in a range from about 0.3 millimeters to about 0.05 millimeters, in a range from about 0.25 millimeters to about 0.05 millimeters, in a range from about 0.2 millimeters to about 0.05 millimeters, in a range from about 0.15 millimeters to about 0.05 millimeters, or in a range from about 0.05 millimeters, including all ranges and subranges therebetween. The laser beam forms a traveling irradiation zone on the surface of the brittle material where the brittle material is heated at the irradiation zone. The method may further comprise cooling the brittle material along the cut path with a cooling fluid incident on the surface of the brittle material, the cooling fluid producing a cooling zone that lags the traveling irradiation zone and causing a crack to propagate along the cut path, detecting a position of a leading tip of the crack relative to a reference location of the traveling irradiation zone and calculating a distance between the crack tip position and the reference location. The method may further comprise comparing the calculated distance to a predetermined set distance and modifying at least one of a power of the laser beam, a traverse speed of the irradiation zone relative to the surface of the glass substrate or a traverse speed of the cooling fluid in response to a difference between the calculated distance and the predetermined set distance. The reference location may be a mid-point of the irradiation zone. However, in other examples the reference location can be the leading tip of the irradiation zone, the trailing tip of the irradiation zone, or any point therebetween. The predetermined set distance can be in a range from about 0 millimeters to about 50 millimeters, for example in a range from about 0 millimeters to about 45 millimeters, from about 0.05 millimeters to about 40 millimeters, from about 0.05 millimeters to about 30 millimeters, from about 0.05 millimeters to about 25 millimeters, including all ranges and subranges therebetween.

The step of detecting the crack tip may comprise using dark field illumination, and may include illuminating the crack with a line illumination and detecting a reflection of the illumination from the crack tip.

In still another embodiment, a method of cutting a glass substrate is disclosed comprising heating the brittle material along a predetermined cut path with a laser beam, the laser beam producing a traveling irradiation zone on a surface of the brittle material where the brittle material is heated at the irradiation zone. The method may further comprise cooling the brittle material along the predetermined cut path with a cooling fluid after the heating, thereby causing a crack to propagate along the cut path, detecting a position of a leading tip of the crack relative to a reference location of the traveling irradiation zone and calculating a distance between the crack tip position and the reference location, comparing the calculated distance to a predetermined set distance, and modifying at least one of a power of the laser beam, a traverse speed of the laser beam or a traverse speed of the cooling fluid in response to a difference between the calculated distance and the predetermined set distance.

A thickness of the brittle material equal to or less than about 0.3 millimeters. For example, the thickness of the brittle material may be in a range from about 0.3 millimeters to about 0.05 millimeters, in a range from about 0.25 millimeters to about 0.05 millimeters, in a range from about 0.2 millimeters to about 0.05 millimeters, in a range from about 0.15 millimeters to about 0.05 millimeters, or in a range from about 0.05 millimeters, including all ranges and subranges therebetween.

In examples, the step of detecting the crack tip position can comprise illuminating the crack with a line laser and detecting bifurcations at the crack tip.

Additional features and advantages of the embodiments disclosed herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description present embodiments intended to provide an overview or framework for understanding the nature and character of the claimed invention. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a perspective view of a laser cutting apparatus according to an example embodiment;

FIG. 2 is a photograph of a freshly-formed edge produced by a conventional laser cutting process illustrating strength-degrading anomalies (arrows) in the fracture surface;

FIG. 3 is a schematic view of an example imaging system used to image a propagating crack according to an embodiment of the present disclosure;

FIG. 4 is a schematic view of another example imaging system used to image a propagating crack according to an embodiment of the present disclosure;

FIG. 5 is a schematic view of still another example imaging system used to image a propagating crack according to an embodiment of the present disclosure;

FIG. 6 is an example feedback loop according to an embodiment of the present disclosure;

FIG. 7 is a plot showing the distance between the tip of a propagating crack and a reference location of an irradiation zone (vertical axis) and the propagation distance of the crack (horizontal axis) for a cutting process without feedback control;

FIG. 8 is a close-up view of a small portion of the plot of FIG. 7 showing the changing crack tip separation over a short distance;

FIG. 9 is a plot showing the distance between the tip of a propagating crack and a reference location of an irradiation zone (vertical axis) and the propagation distance of the crack (horizontal axis) for a cutting process with feedback control for a variety of programmed separation distances;

FIG. 10 is a plot of laser control voltage as a function of crack tip separation from a reference location in the irradiation zone;

FIG. 11 is a plot of failure probability as a function of failure strength (Weibull plot) showing the benefit of a feedback-controlled laser cutting process on glass edge strength.

### DETAILED DESCRIPTION

Reference will now be made in detail to the embodiments of the present disclosure, examples of which are illustrated in the accompanying drawings. Whenever possible, the same reference numerals will be used throughout the drawings to refer to the same or like parts.

While the following disclosure describes the cutting of glass substrates, it will be recognized that the methods described herein are more broadly applicable to the cutting of brittle materials and should not be limited to the cutting of glass materials.

Glass substrates with a thickness greater than about 0.3 millimeters may be laser cut using a laser score-and-break process. In such processes, a laser is used to heat the glass substrate along a predetermined cut path, followed by subsequent fluid quenching along the heated cut path. The heating, followed by fluid quenching, induces a tensile stress in the substrate that exceeds the fracture strength of the substrate, thereby propagating a crack along the cut path. In instances where the laser heating and fluid quenching are used to score the glass substrate, the produced crack extends only partially through the total thickness of the glass substrate, producing a score line. This is due at least in part to the time needed for heat introduced at the surface of the glass substrate by the laser to travel via conduction through the thickness of the glass. For relatively thick glass, stresses induced at the surface of the glass substrate may not extend sufficiently through the thickness of the substrate. Typically, the glass is first scored using the laser and then broken by hand or other mechanical means by imposing a bending moment on the glass substrate that induces a tensile stress perpendicular to the score. The tensile stress propagates the crack through the remainder of the substrate thickness, thereby separating the glass substrate into discrete pieces.

When the glass substrate thickness is reduced, for example to a thickness equal to or less than about 0 3 millimeters, the behavior of the substrate under heating conditions is strikingly different than for thicker glass. For example, glass stiffness is proportional to the glass thickness to the third power (thickness³) and buckling is proportional to the glass thickness squared (thickness²) and hence, under laser heating, buckling changes with thickness, and therefore average power required from the laser beam, and power modulation, will change with thickness. Moreover, heat introduced by the laser can be quickly equilibrated through the glass thickness due to a reduced thermal conduction time. That is, the reduction in glass thickness results in a decrease in the glass surface to volume ratio and a reduction in the time it takes for heat at a surface of the substrate to conduct through the thickness of the substrate to a degree sufficient to promote rapid equilibration of temperature through the thickness of the glass. The combination of rapid thermal equilibration through the glass and rapid radiative heat loss from the glass results in full-body crack propagation. As used herein, full-body crack propagation refers to a crack that extends through the total thickness of the glass substrate and which crack propagates across the glass substrate. A full body crack across the entirety of a major surface of the glass substrate results in a complete separation of the glass substrate. For example, a single glass substrate becomes two glass substrates after the first full-body cut.

Ideally, the full-body crack advances steadily in synchronization with the relative motion of the laser beam along the cut path, and the motion of a quenching (cooling) fluid incident thereon, as the laser beam and the quenching fluid traverse across the glass substrate. However, the advancing crack rarely propagates at a constant speed during laser cutting of such thin, flexible glass as described herein for at least several reasons, including 1) the transient stress generated during the laser heating process can create buckling because thin flexible glass deforms easily, 2) buckling alters the stress distribution around the laser beam and the crack tip, and 3) external stress field variations around the crack tip can easily distort tensile stress at the crack tip since the glass is thin and the stress concentration factor is high at the crack tip. Furthermore, thermal contacts at the glass cutting position on either side of the glass substrate, for example support members, can change the magnitude of the tensile stress at the crack tip and therefore the cutting speed.

Unstable crack propagation due to a mismatch of laser power, variations in cooling process parameters such as cooling fluid consistency (effective cooling relies on a steady, uniform cooling), the laser cutting speed and other factors can individually or combined result in crack arrests or stalling of the crack propagation (cutting process). Crack arrests occur when the crack front advances to a compressive stress zone typically located inside the laser heating spot. As the crack tip advances to the compressive zone created by the laser beam, the crack tip stops, stalls or may deviate slightly from the cutting direction due to the complex shape of the stress field around the laser heating spot. This can generate a crack arrest on the cut edge. As the laser beam and quenching fluid moves away from the crack stall or arrest position, tensile stress develops at the crack arrest and crack propagation re-initiates from its arrested position.

Crack arrests and associated hackle and bifurcations formed on the newly-formed edge surface by the crack arrest can degrade the edge strength of the laser-cut edge. Crack stalling, similar to crack arrest, occurs when there is insufficient tension perpendicular to the crack to propagate the crack, and its effects are similar to those of crack arrests. As such, it is desirable to eliminate or reduce the occurrence of such strength-limiting defects to maximize the edge strength of the separated substrate pieces.

To prevent crack stalling or crack arrest, a method is described below comprising a feedback loop configured to monitor a position of the crack tip, and to monitor a distance between the advancing crack tip and an irradiation zone produced by a laser beam incident on the glass substrate. An error signal produced by a difference between the actual distance and a predetermined distance stored in the memory of a process controller may then be used to control at least one of the laser power (for example, by controlling the laser drive voltage), the traverse speed of the irradiation zone produced by the laser beam over the glass substrate surface, and the traverse speed of a cooling fluid jet over the heated cut path on the glass substrate. Additionally, or alternatively, the controller may control a length of the irradiation zone, an intensity profile of the laser beam, a direction of the laser beam, or any other suitable and controllable process parameter that affects the quality of the cut. By intensity profile what is mean is the intensity of the laser beam as a function of distance across the laser beam in a direction perpendicular to the longitudinal axis of the laser beam. For example, for a laser beam having a circular cross section perpendicular to the longitudinal axis of the laser beam, the intensity profile is the intensity as a function of distance across a diameter of the circular cross section. Typically, laser power is the easiest parameter to control.

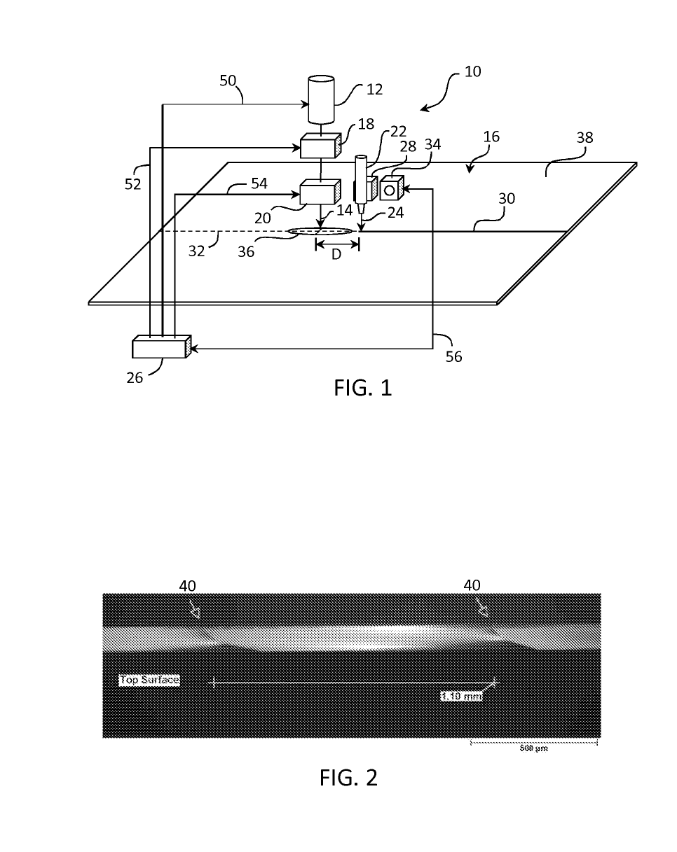

Referring now to FIG. 1, an apparatus 10 is shown comprising a laser 12 for producing a laser beam 14 directed to a glass substrate 16, optionally a laser beam steering apparatus 18 and/or a laser beam modifier 20, a nozzle assembly 22 for emitting cooling fluid 24 supplied by a cooling fluid supply (not shown), a process controller 26, a light source 28 configured to illuminate a crack 30 propagating in the glass substrate along a predetermined cut path 32, and an imaging apparatus 34. Apparatus 10 may also include a glass substrate transport device (not shown) for moving glass substrate 16 relative to laser beam 14 and developing relative motion between laser beam 14 and glass substrate 16.

In some embodiments, the glass cutting methods described herein may be applied to thin glass ribbon, either as the ribbon is drawn in a glass drawing operation, or as a spooled glass ribbon is conveyed from one spool (e.g., a supply spool) to another spool (e.g., a take-up spool). For example, edge portions of the glass ribbon may be removed during a drawing operation or a spooling operation. Accordingly, the glass cutting methods described herein are capable of cutting speeds at least within a range from about 84 millimeter/second to about 250 millimeter/second.

Laser 12 is suitable for producing an irradiation zone 36 on glass substrate 16 by directing laser beam 14 onto a major surface 38 of the glass substrate. The laser light produced by laser 12 should be of a wavelength that is absorbed sufficiently by the glass to heat the glass. For silica-based glass, a suitable laser is a CO₂ laser producing laser light at a nominal wavelength of 10.6 micrometers, although other laser sources and wavelengths are possible. A typical rise and fall time of a radio frequency-excited CO₂ laser is approximately 100 microseconds (μs), or 0.1 millisecond (ms), facilitating rapid changes in output power, e.g., within about 1 millisecond.

Laser beam steering apparatus 18, may be, for example, one or more galvanometer-controlled mirrors, acousto-optical modulators or deflectors (AOM/AOD), or mirrors mounted on piezoelectric actuators, or combinations thereof. Laser beam steering apparatus 18 maybe used to steer laser beam 14 over the surface of glass substrate 16, thereby creating relative motion between an irradiation zone on the glass substrate produced by the laser beam and the glass substrate without the need to produce movement of laser 12. For example, in certain embodiments, described more fully below, glass substrate 16 may be stationary and laser beam 14 steered using steering apparatus 18 to traverse the laser beam across the major surface of the glass substrate. The irradiation zone corresponds to a footprint of the laser beam incident on the glass substrate surface. The laser beam steering apparatus should be capable of at least a one radian per second or faster response time. The resultant linear steering speed is on the order of meters per second given a laser beam path length of approximately one half meter. Since the laser cutting speed is typically less than one meter per second, this requirement can be easily satisfied by commercially available devices.

In some embodiments, it may be more practical to employ a conveyance device, such as air bearings, a roller-mounted table, etc., to move the glass substrate and produce relative motion between the glass and a stationary irradiation zone. The glass substrate may, for example, be translated over a flat support surface, such as an air bearing table. The support surface can include a channel, wherein the glass substrate is positioned such that cut path 32 lies over the channel. In such arrangements, the laser beam may remain fixed while the glass substrate moves. Arrangements such as this may be used, for example, in a process wherein the glass substrate is a continuously moving ribbon. In examples, edge portions of the glass ribbon may be removed as the glass ribbon is traversed relative to the laser beam. For example, drawn glass ribbons may include thickened edge portions formed by contraction of the glass during the drawing process. Such thickened edge portions, referred to as beads, may be removed.

In still another embodiment, the glass substrate and the laser may be stationary, but with the laser beam directed to a steering apparatus 18 comprising a traveling head that shuttles over the surface of the glass substrate along a rail or similar apparatus (not shown). The laser beam can be configured to direct a laser beam to the traveling head, either directly or through one or more mirrors, and a mirror on the traveling head then redirects the laser beam onto the glass substrate. Accordingly, relative motion between the laser beam and the glass substrate is produced by the traveling head. Such methods of producing relative motion between a laser beam and a glass substrate are well-known in the art, and no further description is necessary.

Laser beam modifier 20 can be used to modify the typically circular cross sectional profile of the laser beam to an elongated cross sectional profile to produce an elongated irradiation zone on glass substrate 16. Laser beam modifier 20 may comprise, for example, one or more lenses, such as cylindrical lenses, configured to produce an elongated laser beam cross section and an elongated irradiation zone on the glass substrate, wherein a long axis of the irradiation zone is parallel with cut path 32. As an example, a plano-concave lens can be used to expand the laser beam in one axis, while another cylindrical lens having an optical axis orthogonal to the plano-concave lens, can be used to focus the laser beam in a second, perpendicular axis. Typically, the laser beam incident on the glass substrate (and the resultant irradiation zone) is several tens of millimeters long and less than about 2 millimeters wide. Laser beam shape can be measured using commercial laser beam profiling equipment, or with laser alignment papers, for example laser alignment papers from ZAP-IT®. To use laser alignment papers, the alignment paper is positioned in the path of the laser beam and the laser turned on briefly. Burn marks produced by the laser on the alignment paper can be measured with a micrometer. Laser beam modifier 20 can also be a polygonal scanner, in which case a laser beam profile with a flattened Gaussian distribution can be obtained. Alternatively, asymmetric aspherical lenses can be used to generate a rectangular laser beam with a flat intensity distribution in both the short (minor) and long (major) axes.

As laser beam 14 traverses the glass substrate along cut path 32, glass substrate 16 is quickly heated within irradiation zone 36 produced by laser beam 14 on glass substrate surface 38. The heating produced in the irradiation zone causes an expansion of the glass substrate within the irradiation zone. Nozzle assembly 22 follows behind the irradiation zone relative to the direction of traverse over the cut path and a cooling fluid 24 is directed at the heated glass along the cut path. The cooling fluid may be a gas, a liquid, or a combination of both (e.g., a mist or aerosol). Rapid cooling produced by the cooling fluid creates a tensile stress within the glass substrate. If the heating and cooling are begun at the location of a pre-existing flaw in the glass, for example a small, intentionally introduced crack, the tensile stress produced by the heating and cooling advances the pre-existing crack at the crack tip along the cut path followed by the laser beam and the cooling fluid.

Unfortunately, for at least the reasons described supra, crack stalling and/or crack arrest can occur, and these deviations in the progress of the crack front as it traverses along the cut path can produce irregularities in the newly-formed edge surfaces of the glass. FIG. 2 is a photograph of the cut edge of a glass substrate 16 illustrating irregularities 40 produced by crack arrests. The glass substrate was comprised of a silica-based glass and had a thickness of 100 micrometers and a CTE of approximately 35×10⁻⁷/° C. A CO₂ laser beam with a dimension of 38 millimeters long and 1.5 millimeters wide was used to heat the glass substrate at surface 38 (FIG. 1), and a water mist was used to cool the glass substrate along the heated cut path. The distance between the mist jet and the receding (trailing) edge of the laser beam was approximately 5 millimeters. A laser power of approximately 40 watts and a laser cutting speed of 280 millimeters per second was used in the process. The irregularities 40 represent the shape of the crack front at the time of the arrest. Such irregularities can reduce the strength of the individual glass sheets produced by the cutting operation such that if the newly-formed edge surface of the resultant individual glass substrate is placed in tension, such as by bending, a crack may originate from the irregularity and the glass substrate may break. The irregularities may include bifurcations of the crack front. Such weakened edges are therefore a liability if incorporated into a downstream product, particularly one where the glass substrate may undergo bending.

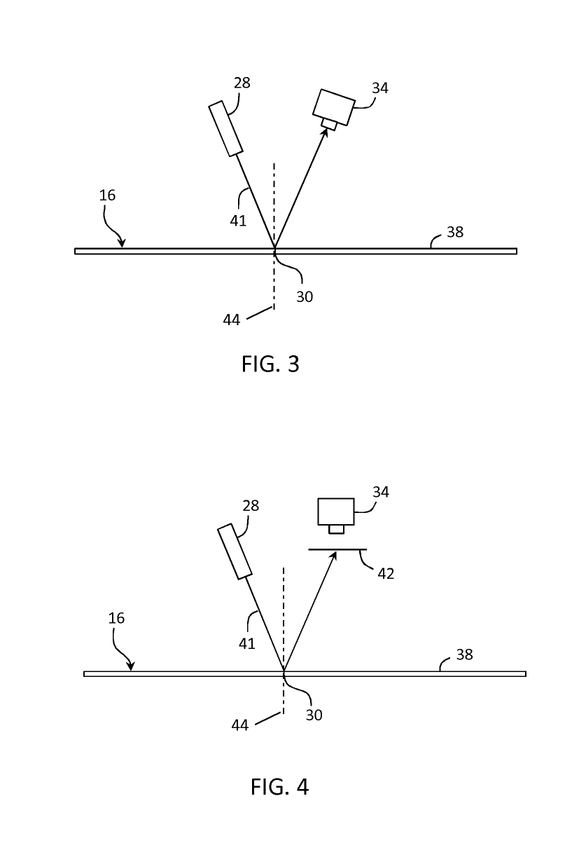

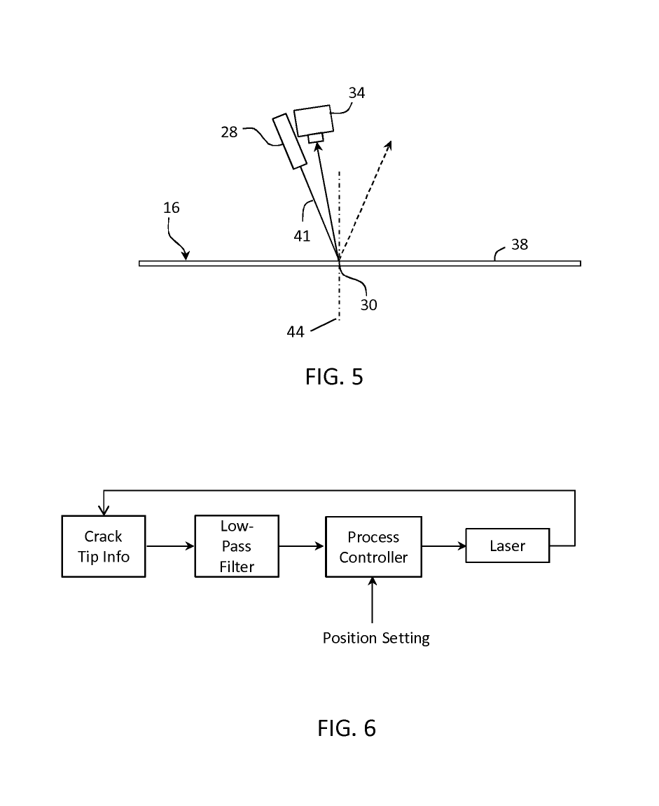

As described herein, crack arrest and crack stalling effects can be minimized or eliminated by employing a feedback control loop in the cutting process based on the position of the crack tip relative to the irradiation zone produced by the laser beam on the surface of the glass substrate. The position of the crack tip can be determined by real-time processing of video images taken in the vicinity of the crack tip. Accordingly, apparatus 10 further includes light source 28 configured to illuminate the advancing crack sufficiently for the crack tip to be imaged by imaging apparatus 34. Light source 28 may be a laser for example, separate from laser 12, wherein light from light source 28 has been elongated to a line extending in a direction parallel with the cut path. The elongated light 41 from light source 28 can be directed at cut path 32, and may overlap with the CO₂ laser beam. Light from the light source 28 will be reflected by the advancing crack, allowing imaging apparatus 34 to image the crack. As shown in FIG. 3, light source 28 may direct light at the cut path at an angle relative to glass substrate surface 38. In another embodiment, shown in FIG. 4, light from light source 28 may be reflected from crack 30 and be incident on a projection screen 42, wherein imaging apparatus 34 images the crack from the projection screen. Imaging apparatus 34 may include an imaging sensor, wherein the imaging sensor is located on the opposite side of the cut path from the light source. That is, on the opposite side of a plane 44 extending perpendicular to substrate surface 38 parallel to and intersecting with crack 30. In still another embodiment shown in FIG. 5, light source 28 and imaging apparatus 34 (e.g. imaging sensor) may be on the same side of cut path 32 (same side of plane 44), as shown in FIG. 5, such that the cut path is illuminated by dark field lighting. As used herein, dark field lighting occurs when, in the absence of an anomaly, such as a crack or surface defect, light from the light source that is reflected from surface 38 of the glass substrate would be reflected from surface 38 at an angle that does not allow the reflected light to enter the focusing lens of the imaging apparatus. To wit, the imaging apparatus “sees” darkness. However, an anomaly causes reflection of the light (e.g., scattering), at other angles from the normal reflection angle (reflection angle in the absence of an anomaly), such that the scattered light is observed by the imaging apparatus. An LED line light source, for example, can be used to produce dark field illumination of the rectangular area at the crack tip and along the cutting direction. That is, a light source that illuminates the crack with a line of light from the LED source or sources. The imaging system then picks up only light reflected by crack 30. In still another embodiment, the crack tip location, and progress along the cut path, can be determined using one or more acoustic detectors arrayed along the cut path.

Detecting crack tip position relative to irradiation zone 36 during laser cutting requires adequate image acquisition and processing capabilities. For example, at a cutting speed of 400 millimeters/s, a crack tip movement of 1 millimeter will require the feedback loop to respond within approximately 2 milliseconds (ms) or less. This in turn requires image acquisition and laser response, for example, within about 1 milliseconds. Imaging of the crack tip occurs in real time such that progress of the crack tip can be determined. For example, successive images of the crack tip can be made at high frequency, producing relatively high spatial resolution tracking of the crack tip location. Current state-of-the-art image processing units are capable of up to 1 million frames per second. A one millisecond time delay would require the image processing unit to acquire and process 1000 image frames per second, well within reach of current image acquisition and processing technology.

The imaging apparatus may be used to also locate the position of the irradiation zone, and more particularly a reference location within the irradiation zone. For example, the position of the irradiation zone can be determined using position sensors on the laser beam steering apparatus. By correlating the position of the irradiation zone on the glass substrate with information from the laser beam steering apparatus, the irradiation zone, or any portion thereof, can be determined. Similarly, position information can be derived from position sensors located on or in the conveyance device if a conveyance device is used to move the glass substrate.

In the case that the irradiation zone produced by the laser beam is stationary, and the glass substrate is moved relative to the stationary laser beam, the position of the irradiation zone, and more particularly the position of the reference location within the irradiation zone, can be determined using the previously described laser alignment papers. In this configuration, the reference location is a known location, does not move, and only the crack tip position need be monitored.

Once the crack tip is acquired by imaging apparatus 34, a position of the crack tip may be detected by filtering the output of the imaging apparatus at process controller 26, producing an intensity map of the acquired image and applying a threshold detection filter to the output. For example, the image intensity output can be compared to a predetermined threshold value input into, for example stored in, process controller 26. An image intensity that exceeds the predetermined threshold intensity value stored in a memory of the process controller can then be used to designate the position of the crack tip.

Both position information related to the irradiation zone location and position information related to the crack tip location can be provided to process controller 26. Process controller 26 can then use a stored instruction set to calculate a distance D between a selected portion (e.g., a reference location) of the irradiation zone and the crack tip, and to compare the calculated distance to a predetermined distance set point provided to the process controller, such as through an input channel or maintained within the process controller memory. While any reference position within the irradiation zone can be used for determining a distance between the crack tip and the irradiation zone, for example a leading edge of the irradiation zone, a trailing edge of the irradiation zone, or any point therebetween, a mid-point of the irradiation zone may be the easiest to consistently determine and use as a reference location.

Once a distance between the crack tip and the irradiation zone reference location has been calculated, process controller 26 produces an error signal proportional to the difference between the calculated actual distance and the set point distance, and uses the error signal to control at least one of the laser power, the traverse speed of the laser beam or the traverse speed of the cooling fluid. For example, in reference to FIG. 1, laser 12 may be controlled by process controller 26 through control line 50, laser beam steering apparatus 18 can be controlled through control line 52, laser beam size and/or shape can be controlled through control line 54 which can be used, for example, to change the orientation of the lenses used to adjust the laser beam shape, and cooling fluid 24 can be controlled by control line 56 which can be used for example to control a traverse speed of nozzle assembly 22. Additionally or alternatively, nozzle assembly 22 may be mounted such that a relative position between the cooling fluid and the irradiation zone can be varied. For example, in embodiments where the laser beam is stationary and the brittle material moves relative to the laser beam, nozzle assembly 22 may be movable such that a distance between the irradiation zone and the cooling fluid in a direction along the cut path may be varied by process controller 26. Other process parameters that may be controlled by process controller 26 can include a steering direction of the laser beam and/or the glass substrate through these or other control line functions.

An example feedback loop using the crack tip position relative to the irradiation zone is shown in FIG. 6. The laser power, cooling and laser cutting speed and other process conditions are pre-set prior to engagement of the feedback loop. Once the cutting process initiates, imaging apparatus 34 is used to detect the position of the crack tip and to supply image data to the process controller through a low pass filter. Process controller 26 can be a computer or a stand-alone control interface, and compares the position of the crack tip with a predetermined and desired crack tip position that has been input to the process controller. A proportional—integral—derivative (PID) controller may be used with embodiments described herein. Process controller 26 may generate and provide, for example: 1) a signal to the laser to adjust the laser beam power if necessary, and/or 2) a signal to the laser beam steering unit, which, if necessary, shifts the laser beam away or backwards toward the crack tip. If the crack tip lags too far behind the laser beam, the laser power can be adjusted higher and/or the laser beam may be steered back toward the crack tip. On the other hand, if the crack tip approaches too close to the trailing (receding) edge of the laser beam, the laser power can be reduced and/or the laser beam may be steered away from the crack tip. Similar movements may be performed with the cooling nozzle and the area of incidence of the cooling fluid on the surface of the brittle material.

### EXAMPLES

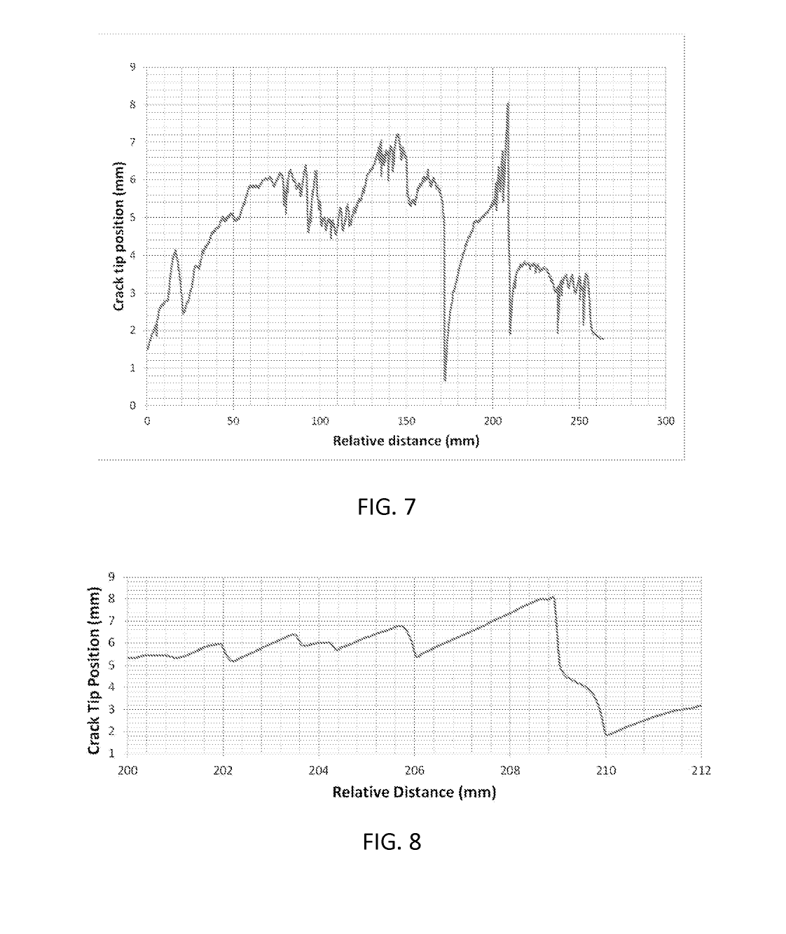

FIG. 7 is a plot of crack tip position relative to the reference position (irradiation zone middle) of a heating laser beam (i.e. laser beam 14) as a function of distance along a cut path in a cutting apparatus without feedback control. The plot shows dramatic variations in distance between the crack tip and the reference location as the crack progressed along the cut path. FIG. 8 is a high resolution plot of a portion of FIG. 7 showing variations in crack tip separation of up to 6 millimeters over a propagation distance of only 2 millimeters (e.g. between 208 millimeter and 210 millimeter on the horizontal x-axis). Redrawn alumino borosilicate glass of 100 micrometer thickness was used in the example. A 100 W CO₂ laser, made by Synrad, model Firestar t-100 was used. The laser output power was 40 watts and the cutting speed was 60 millimeters/second. The laser beam had an elongated shape of 38 millimeters long×1.5 millimeters wide on the glass as measured with Beam Monitor HQ from PRIMES. The long dimension was parallel with the cut path. No cooling fluid was applied in the example.

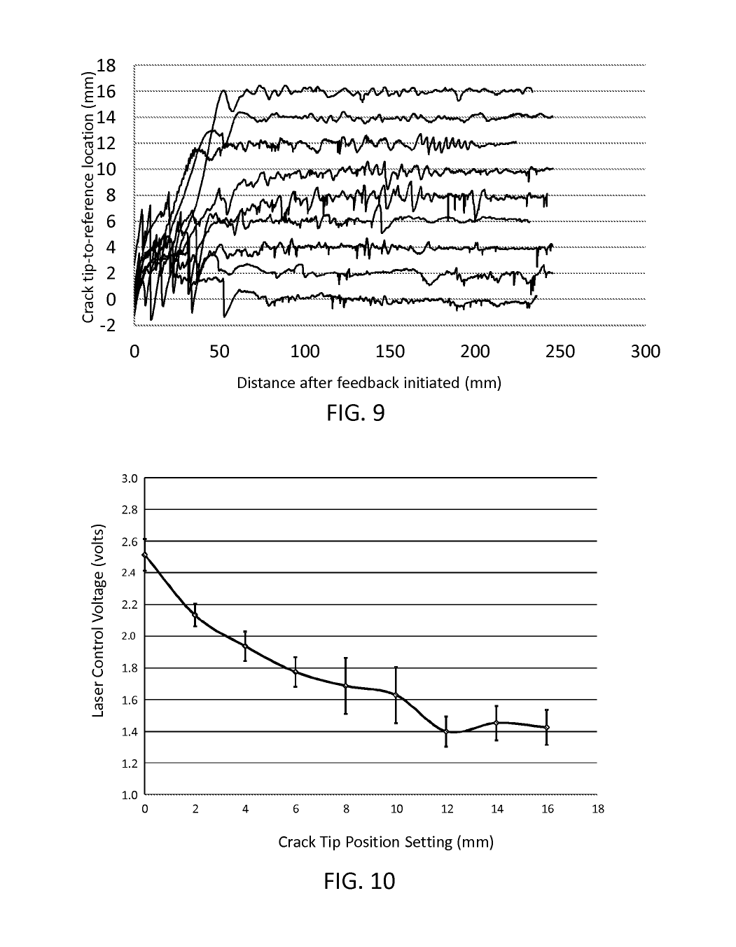

FIG. 9 is a plot of crack tip position relative to the irradiation zone reference location (middle of the irradiation zone) as a function of the crack tip progression from the instant of feedback initiation (0 position on horizontal x-axis). The data show a consistent crack tip-to-reference location separation after an approximately 50 millimeter propagation of the crack tip. The data also show, from bottom to top (referring to the curves at the right side of the plot) from a zero millimeter separation to a 16 millimeter separation. Feedback control in this example was performed by varying the control voltage supplied to the CO₂ laser, and thereby the output power of the laser beam. Redrawn aluminoborosilicate glass of 100 micrometer thickness was used in the example. A 100 watt CO₂ laser, made by Synrad, model Firestar t-100 was used. The cutting speed was 40 millimeter/second. The laser beam had an elongated shape of 38 millimeters×1.5 millimeters on the glass as measured with a Beam Monitor HQ from PRIMES. Imaging of the crack tip position was carried out using a dark field illumination technique as shown in FIG. 5. Video image acquisition was carried out at a frame rate of 1000 Hz using an Ethernet-based area scan video camera (DALSA Genie HM640). No cooling fluid was applied in the example.

FIG. 10 is a plot of laser control voltage as a function of the crack tip separation setting input to the process controller. The data show an approximately linear relationship between the crack tip position setting (distance from crack tip to reference location) and the voltage necessary to maintain that relative position.

In another example, a CO₂ laser cutting system using a feedback-controlled cutting approach was used to cut Corning® Willow® glass having dimensions of 20 millimeter×100 millimeter and 130 micrometer thickness. The system used a CO₂ laser, manufactured by Coherent Incorporated (model E-150). The output of the laser was shaped into an elliptical shape with a dimension of 2.7 millimeters×36 millimeters. The glass was translated on a translation stage with a machined slot. The slot width was 6.35 millimeters with a depth of 6.35 millimeters to avoid contact of the newly formed glass edges with the slot bottom. Laser cutting was performed on the glass substrate along the slot centerline. A cooling air nozzle, with an outer diameter of ⅛″ (3.18 millimeters) and an inner diameter of 1/16″ (1.59 millimeters) was placed about 8 millimeters away from the center of the laser beam. The air flow through the nozzle was set at about 20 standard cubic centimeters per minute. A crack tip imaging system, as illustrated in FIG. 5, was used. The images were taken with a Basler Ace ACA2000-340km Camera link camera. The image acquisition rate was set at 2800 Hz with the camera directed to a preset area of interest. The crack tip position was set at 6 millimeters from the center of the laser beam.

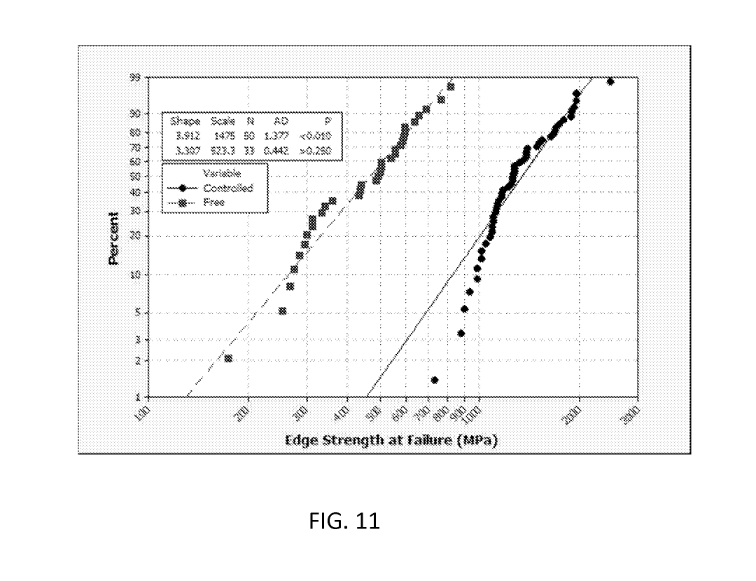

FIG. 11 is a Weibull plot of edge strength at failure in megaPascal for a sample of glass substrates, cut both without feedback control of crack tip position and with feedback control. A total of 33 samples cut without feedback control (squares, left) were tested and 50 samples from the feedback controlled cutting approach (diamonds, right) were tested. The samples were tested to failure in a two-point bending test wherein the samples were separately manually affixed to two parallel plates with the long edges (100 millimeter edges) arranged perpendicular to the plates. The distance between the parallel plates was then reduced, thereby reducing a bend radius of each sample along the 100 millimeter edges until failure of the sample occurred. Stress at failure was calculated from the bend radius information. The data show an almost 400% increase in edge strength compared to cutting without feedback control. For example, cutting without feedback control yielded an approximately 260 megaPascal (MPa) edge strength at a failure probability of 10%, whereas cutting using feedback control as described herein yielded an edge strength of approximately 1000 megaPascal at the same failure probability.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

What is claimed is:

1. A method of cutting a brittle material comprising:
heating the brittle material along a predetermined cut path with a laser beam, the laser beam forming an irradiation zone on a surface of the brittle material;
cooling the brittle material along the predetermined cut path with a cooling fluid after the heating, thereby causing a crack to propagate along the cut path;
detecting a position of a leading tip of the crack relative to a reference location of the irradiation zone and calculating a distance between the crack tip position and the reference location;
comparing the calculated distance to a predetermined set distance; and
modifying at least one of a power of the laser beam, a traverse speed of the irradiation zone or a traverse speed of the cooling fluid in response to a difference between the calculated distance and the predetermined set distance.

2. The method according to claim 1, wherein the reference location is a mid-point of the irradiation zone.

3. The method according to claim 1, wherein the predetermined set distance is in a range from about 0 millimeters to about 50 millimeters.

4. The method according to claim 1, wherein a thickness of the brittle material is equal to or less than about 0.3 millimeters.

5. The method according to claim 4, wherein the thickness of the brittle material is equal to or less than about 0.150 millimeters.

6. The method according to claim 1, wherein the brittle material is a glass substrate.

7. The method according to claim 1, wherein the brittle material comprises a ceramic.

8. The method according to claim 1, wherein the step of detecting the position of the leading tip of the crack comprises illuminating the crack with an illumination source.

9. The method according to claim 1, wherein the step of detecting the position of the leading tip of the crack comprises imaging the crack.

10. A method of cutting a brittle material comprising:
heating a brittle material along a predetermined cut path on a surface of the brittle material with a laser beam incident on the surface of the brittle material, the laser beam forming a traveling irradiation zone on the surface of the brittle material;
cooling the brittle material along the cut path with a cooling fluid incident on the surface of the brittle material, the cooling fluid producing a cooling zone that lags the traveling irradiation zone and causing a crack to propagate along the cut path;
detecting a position of a leading tip of the crack relative to a reference location of the traveling irradiation zone and calculating a distance between the crack tip position and the reference location;
comparing the calculated distance to a predetermined set distance; and
modifying at least one of a power of the laser beam, a traverse speed of the laser beam or a traverse speed of the cooling fluid in response to a difference between the calculated distance and the predetermined set distance.

11. The method according to claim 1, wherein the reference location is a mid-point of the irradiation zone.

12. The method according to claim 1, wherein the predetermined set distance is in a range from about 0 millimeters to about 50 millimeters.

13. The method according to claim 1, wherein a thickness of the brittle material is equal to or less than about 0.3 millimeters.

14. The method according to claim 13, wherein the thickness of the brittle material is equal to or less than about 0.150 millimeters.

15. The method according to claim 1, wherein the brittle material is a glass substrate.

16. The method according to claim 1, wherein the brittle material comprises a ceramic.

17. The method according to claim 1, wherein the step of detecting the position of the leading tip of the crack comprises illuminating the crack with a line illumination and detecting reflection from the leading tip of the crack.

18. A method of cutting a glass substrate comprising:
heating the brittle material along a predetermined cut path with a laser beam, the laser beam producing a traveling irradiation zone on a surface of the brittle material;
cooling the brittle material along the predetermined cut path with a cooling fluid after the heating, thereby causing a crack to propagate along the cut path;
detecting a position of a leading tip of the crack relative to a reference location of the traveling irradiation zone and calculating a distance between the crack tip position and the reference location;
comparing the calculated distance to a predetermined set distance; and
modifying at least one of a power of the laser beam, a traverse speed of the laser beam or a traverse speed of the cooling fluid in response to a difference between the calculated distance and the predetermined set distance.

19. The method according to claim 18, wherein a thickness of the glass substrate is equal to or less than 0.3 millimeters.

20. The method according to claim 18, wherein the step of detecting the position of the leading tip of the crack comprises illuminating the crack with a line laser and detecting bifurcations at the leading tip of the crack.
